(19) United States
(12) Patent Application Publication
(10) Pub. No.: US 2023/0371724 A1
(43) Pub. Date: Nov. 23, 2023

(54) EXPANDABLE INFUSION CONTAINER

(71) Applicant: SWISS TEA INNOVATION AG, Olten (CH)

(72) Inventors: Joseph Alain SCHERRER, Wangen b. Olten (CH); Franco DEL BON, Aarburg (CH); Theodor WÜST, Wetzikon (CH)

(73) Assignee: SWISS TEA INNOVATION AG, Olten (CH)

(21) Appl. No.: 18/044,679

(22) PCT Filed: Sep. 2, 2021
(86) PCT No.: PCT/EP2021/074285

§ 371 Date: Mar. 9, 2023

(30) Foreign Application Priority Data
Sep. 10, 2020 (CH) 01138/20

(51) Int. Cl. A47G 19/16; B65D 21/08; B65D 43/02

(52) U.S. Cl. CPC A47G 19/16; B65D 21/086; B65D 43/021; B65D 2401/10; B65D 2543/00555

(57) ABSTRACT

An expandable infusion container (20) for receiving a dried infusion substance for preparation of an infusion beverage is disclosed. This comprises a base part (21), a lid part (22) and a wall part (23) connecting the base part (21) and the lid part (22). The wall part (23) has a variable length and is fastened with a first end (232) to the base part (21) and is connected with its second end (231) to the lid part (22). The lid part (22) and the base part (21) are connected to one another via a destructible guarantee seal (24).

The present invention relates to an expandable infusion container for preparation of an infusion beverage comprising a destructible guarantee seal according to the preamble of the independent claims.

An infusion beverage is understood in connection with the present invention as any type of beverage that can be prepared, starting from a dried infusion substance, by contact with a cold or hot infusion liquid. A typical infusion beverage is tea, for example, that is prepared by brewing tea leaves or herbs with hot water.

It is known that different types of teas require a comparatively long brewing of several minutes duration to optimally develop their aroma. The contact time between the tea leaves and the brewing water must therefore be sufficiently long.

Known from EP 3 119 245 B1 is a tea preparation device and a method which allows a measured amount of a dried infusion substance to be brought in contact with an infusion liquid over a certain contact time. This is made possible by an expandable infusion container. In order to bring the infusion liquid into the container, a lid of this container is pierced with a filling needle and the infusion liquid is introduced into the container through this filling needle. For emptying the infusion container an outlet valve is provided which opens when an excess pressure is exceeded inside the infusion container. The excess pressure is achieved by compressing the container with an expressing piston.

Depending on the dried infusion substance, this can be present in a more or less compressed form. Since the container is expandable, the base of the container and the lid of the container are not necessarily always in the same position with respect to one another. In addition, it is not immediately visible on the compressed container after expressing whether this has already been used once or not.

It is the object of the invention to eliminate at least one or more disadvantages of the prior art. In particular, an infusion container is to be provided which can be easily stored and transported and in particular occupies a small volume. Preferably it should be apparent on the infusion container whether this has already been used.

This object is achieved by the devices defined in the independent claims. Further embodiments are obtained from the dependent claims.

The present invention relates to an expandable infusion container for receiving a dried infusion substance for preparation of an infusion beverage. The infusion container comprises a base part, a lid part and a wall part connecting the base part and the lid part. The wall part has a variable length and is fastened with a first end to the base part and is connected with its second end to the lid part. The lid part and the base part are connected to one another via a destructible guarantee seal.

The connection between the lid part and the base part enables the lid part and the base part to have a specific position with respect to one another. The destructible guarantee seal ensures that it is directly apparent at the infusion container whether this has already been used or not. The destruction of the guarantee seal enables the position of the lid part relative to the base part to be changed and the infusion container can therefore be brought into an expanded position.

The guarantee seal can be configured as a material thin point such as a tear-off film, for example. A tear-off film is a point in the material having a small height or thickness in relation to the width. A tear-off film is typically thicker than 10 μm and preferably does not exceed a thickness of 500 μm. It is in particular at least half as thick as an adjoining wall.

A tear-off film is easy to manufacture and nevertheless enables a complete connection of two parts so that no dirt can penetrate through the guarantee seal in the area of the guarantee seal.

Alternatively it is possible to configure the guarantee seal as a plurality of tear-off webs.

As a result of the configuration as a tear-off web, two elements are connected together over a shorter length compared to a tear-off film which reduces the force required to open the guarantee seal.

Preferably the guarantee seal is formed as an integral component of the base part.

The base part can thus be fabricated jointly with the guarantee seal, in particular in one piece. This reduces the number of working steps to manufacture the infusion container.

The base part can comprise a hollow-cylindrical wall that extends from the base part in the direction of the lid part. This wall can be divided by the guarantee seal into a base ring) and a separating ring. Preferably this hollow-cylindrical wall extends along the periphery of the base part.

The wall makes it possible to provide a protected interior between the base part and the lid part in which the wall part having the variable length can be arranged. This is protected by this hollow-cylindrical wall against environmental influences and/or action of force from outside.

As a result of the division into a base ring and a separating ring, a part of the hollow-cylindrical wall can thus be separated from the base part. Elements connected to the separating ring can thus be moved relative to the base part after separating the separating ring.

Preferably the second end of the wall part is clamped between the lid part and the separating ring.

By separating the separating ring and subsequently raising the separating ring from the base ring, the second end of the wall part is therefore also moved relative to the base ring and therefore relative to the base part. This makes it possible to expand the infusion container by a lengthening of the wall part.

The clamping between the lid part and the separating ring ensures a liquid-tight connection between the lid part and the wall part.

For clamping the wall part the lid part can have two concentric webs which are or can be brought into operative connection with the separating ring.

The two webs thus substantially provide a groove in which the separating ring can be introduced.

The separating ring can thus be simply and securely connected to the lid part.

A snap connection can be provided for connection of the base part to the lid part.

A snap connection has the advantage that an elevated initial force compared with the retaining force must be applied to make the connection. The force must be accordingly large to release the connection again. With an appropriate configuration of the snap connection, for example, in particular with an undercut or with elements on the webs that engage behind the separating ring in some areas, it is no longer possible to release this snap connection without destroying it.

In order to provide the snap connection a projection can be provided on one of the concentric webs for engagement in a corresponding recess on the separating ring.

A reliable simple connection between the lid part and the separating ring can thus be created.

The snap connection is preferably configured in such a manner that a force for releasing this snap connection, is greater than the force for tearing open the guarantee seal, in particular by a multiple.

One or more axial extensions which overlap the guarantee seal can be provided at least on one of the concentric webs.

The guarantee seal can thus be protected on the one hand with respect to external influences, on the other hand, in particular when the guarantee seal has openings, the guarantee seal can be closed so that no impurities can penetrate the guarantee seal.

A projection for engaging in a corresponding recess on the base ring can be provided on the axial extension(s).

The projection in cooperation with the recess enables a circumferential seal between the base ring and the lid part.

Preferably the infusion container has an inlet valve which is arranged on the lid part.

As a result of the specific configuration of an inlet valve on the lid part, an expensive piercing mechanism on a tea preparation device can be dispensed with. The configuration with an inlet valve additionally allows a simple filling process in the expandable infusion container which is reliably reproducible.

The infusion container can have an outlet valve which is arranged on the base part. Due to an outlet valve the infusion container can be held in the expanded state until this outlet valve is opened. An infusion liquid poured into the infusion container can thus be held in contact with a dried infusion substance located in the container for a predetermined time interval.

The outlet valve can be opened mechanically, for example, after expiry of the duration and/or as a result of the build-up of an excess pressure in the infusion container.

A filter sieve can be arranged inside the infusion container, wherein the filter sieve is preferably arranged on the base part.

The filter sieve closes a dispensing opening of the infusion container and prevents dried infusion substance from being dispensed from the infusion container with the infusion beverage.

In addition, a support can be formed on the base part of the infusion container, which cooperates with the lid part and supports this.

The support can be configured as part of the filter sieve and in particular can form an integral part of the filter sieve.

With the exception of the presently described elements, the infusion container can in particular be configured according to the infusion container which is described and claimed in EP 3 119 245 B1. The infusion container is therefore in particular configured for receiving an infusion liquid in a fluid-tight manner and configured to be expanded from a collapsed shape into an expanded shape by introducing infusion liquid. Alternatively to this embodiment, said container can be additionally configured with an inlet valve as presently described. The infusion container is no longer pierced for filling but is filled through the inlet valve.

The presently described infusion container is in particular suitable for carrying out the method which is described and claimed in EP 3 119 245 B1. The method in particular comprises a method in which a measured amount of a dried infusion substance is brought in contact with a measured amount of an infusion liquid and the infusion beverage is thereby produced. The dried infusion substance is provided in the infusion container which is initially present in a collapsed form and is expandable into an expanded form. The infusion liquid is introduced into the infusion container. The infusion container is expanded so that the dried infusion substance in the infusion container is brought in contact with the infusion liquid for a contact time to form the infusion beverage. The infusion container is then returned at least partially into its collapsed state by compressing and in so doing the infusion beverage is expelled at least partially from the infusion container.

The invention is explained in detail hereinafter with reference to an exemplary embodiment by reference to schematic figures. In the figures:

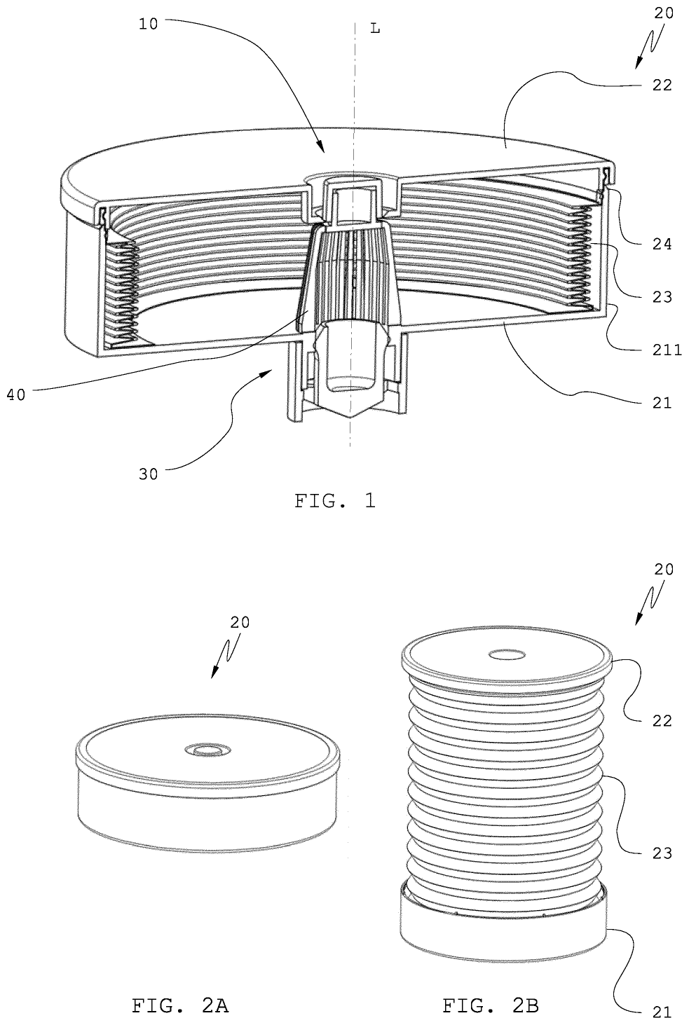

FIG. 1: shows a perspective sectional view of an infusion container;

FIG. 2A: shows a perspective view of the infusion container from FIG. 1 in a collapsed form;

FIG. 2B: shows a perspective view of the infusion container of FIG. 2A in an expanded form;

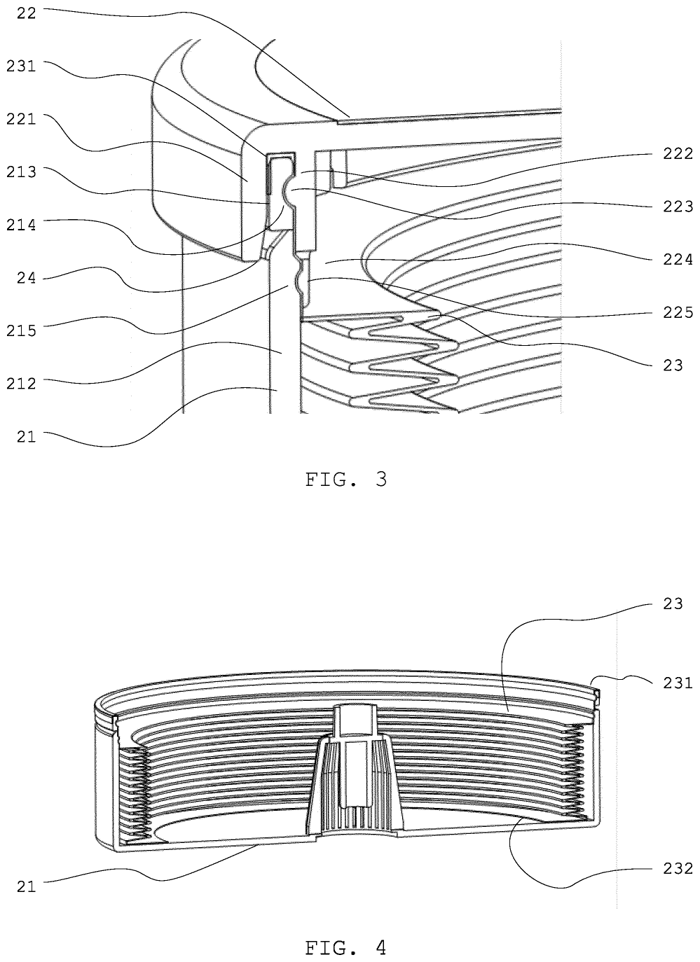

FIG. 3: shows a detailed view from FIG. 1;

FIG. 4: shows a perspective view of the infusion container from FIG. 1 during manufacture;

FIG. 5: shows a detailed view from FIG. 4;

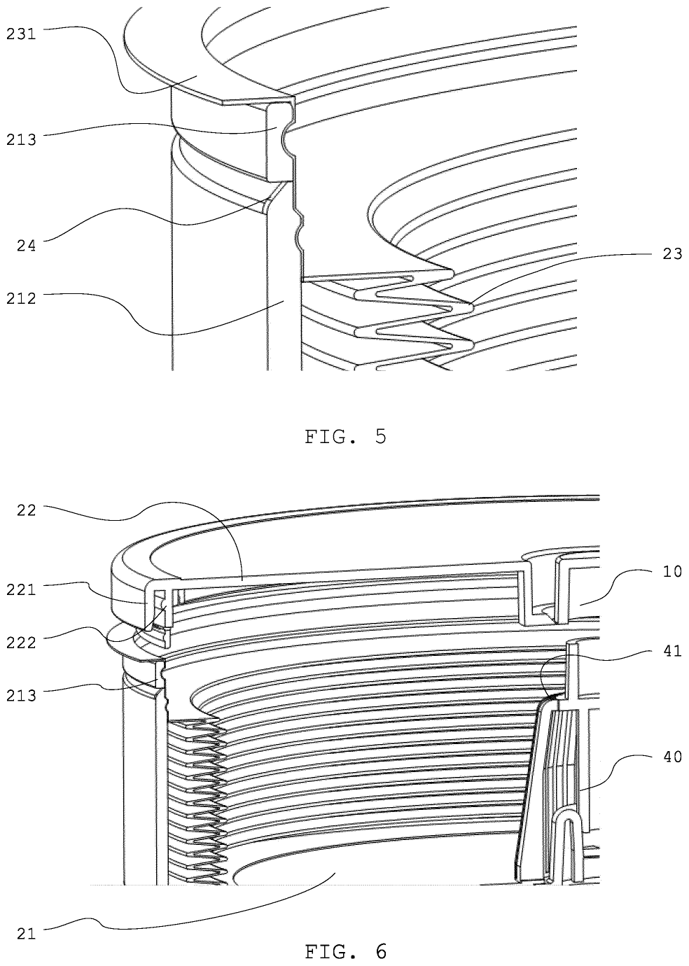

FIG. 6: shows a perspective view of the infusion container from FIG. 1 during manufacture;

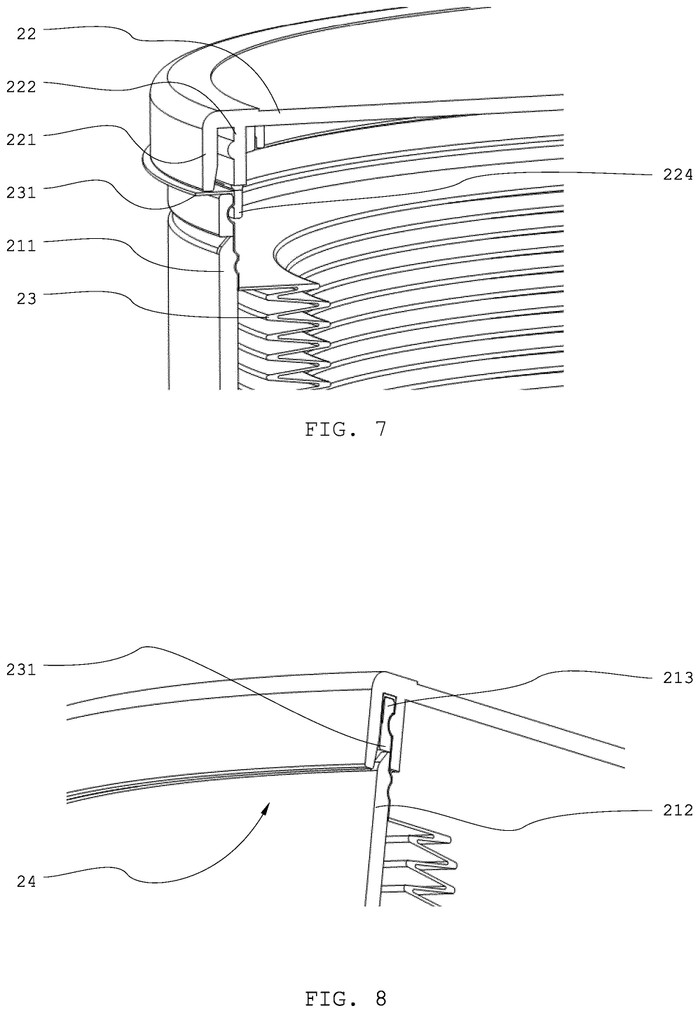

FIG. 7: shows a detailed view of a further manufacturing step;

FIG. 8: shows a perspective view of the assembled infusion container;

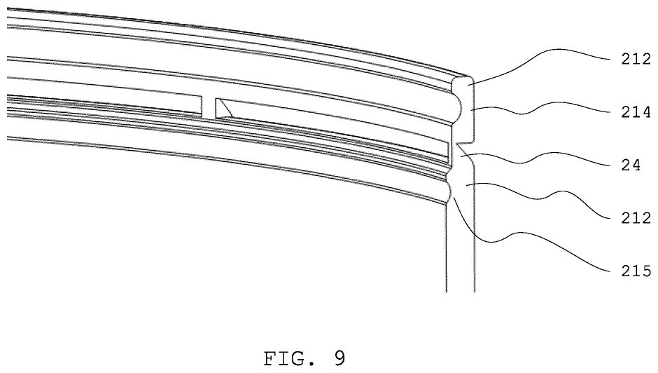

FIG. 9: shows a detailed view of a guarantee seal;

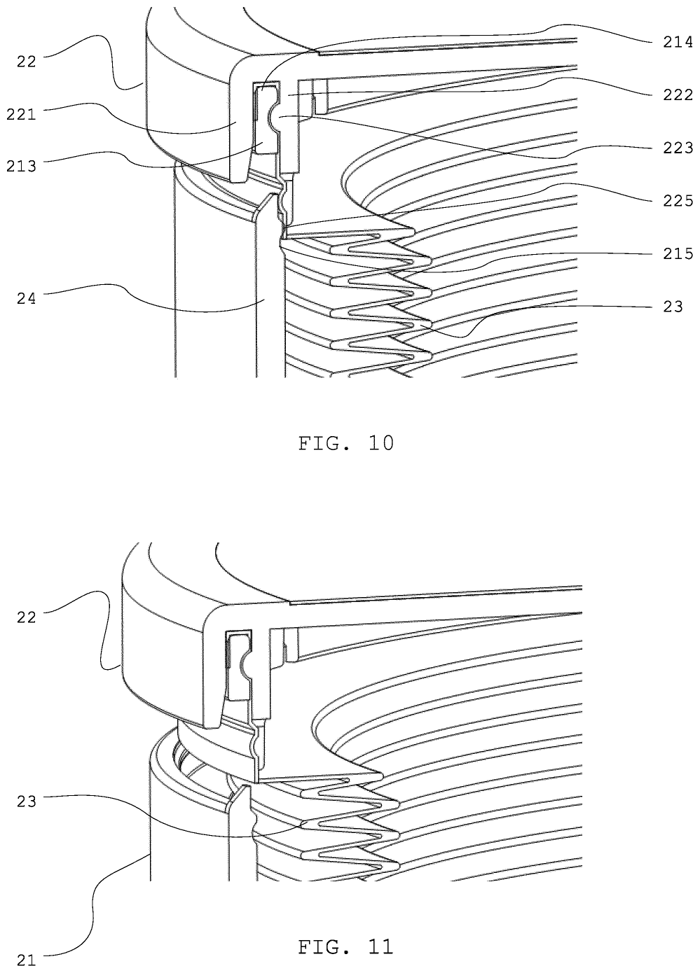

FIG. 10: shows the view according to FIG. 3 after breaking open the guarantee seal;

FIG. 11: shows the view according to FIG. 10 after raising the lid part.

For the sake of better clarity in all the figures the dried infusion substance optionally located in the infusion container 20 is not shown.

FIG. 1 shows a perspective sectional view of an infusion container 20. The infusion container 20 has an inlet valve 10 and an outlet valve 30 with a dispensing opening. The infusion container itself comprises a base part 21, a lid part 22 and a wall part 23. The wall part 23 is expandable and in the present case is configured in the form of a bellows. The wall part 23 is on the one hand connected in a liquid-tight manner to the base part 21 and on the other hand is connected in a liquid-tight manner to the lid part 22. This wall part 23 is enclosed by the base part 21 and by the lid part 22. To this end, a hollow-cylindrical wall 211 extending in the direction of the lid part 22 is provided on the base part 21 on the periphery thereof. As can be seen in FIG. 1, the inlet valve 10 is configured as an integral component of the lid part 22. It can also be seen that the outlet valve 30 is at least partially configured as an integral component of the base part 21. A filter sieve 40 which is arranged upstream of the dispensing opening and therefore of the outlet valve 30 is also illustrated.

The infusion container 20 according to FIG. 1 is configured to be substantially rotationally symmetrical and has a central axis L. This also defines an axial direction. A central axis is also provided in non-rotationally symmetrical configurations of the infusion container 20. This is substantially defined by the connection of inlet valve 10 and outlet valve 30. A flow direction which runs from the inlet valve 10 to the outlet valve 30 is also defined by the inlet valve 10 and the outlet valve 30.

FIG. 2A shows a perspective view of the infusion container 20 from FIG. 1 in a collapsed form. As can be seen from FIG. 2A and from FIG. 1, in the collapsed form the base part 21 is connected to the lid part 22 via the wall arranged on the periphery thereof and the integrally arranged guarantee seal 24.

FIG. 2B shows a perspective view of the infusion container from FIG. 2A in an expanded form. By introducing an excess pressure via the inlet valve 10 (see FIG. 1), the guarantee seal 24 of the wall 221 of the base part 21 is broken open and the wall part 23 expands as a result of the filling of infusion liquid into the infusion container 20. It is understood that before introducing the excess pressure, the inlet valve 10 was opened. The infusion container 20 subsequently remains in this expanded form for a predetermined time and is then compressed to expel the infusion beverage. It is understood that the outlet valve 30 (see on this matter FIG. 1) is opened in particular before the compression and the infusion beverage is dispensed through this outlet valve 30.

FIG. 3 shows a detailed view from FIG. 1. This shows a section of the connection between the lid part 22 and the base part 21. A first web 223 and a second web 222 are formed on the lid part 22. The first web 221 runs along the periphery of the lid part 22. The second web 22 is radially offset inwardly in relation to the first web 221. These two webs 221 and 222 jointly form a groove for receiving a corresponding counter-piece. The counter-piece is configured as part of the hollow-cylindrical wall 211 of the base part 21. The hollow-cylindrical wall 211 is divided into a base ring 212 and a separating ring 213. The separating ring 213 is held in the groove between the webs 221 and 222.

The separating ring 213 is connected to the base ring 212 via a guarantee seal 24. In the present case, the guarantee seal 24 consists of individual tear-off webs (see on this matter also FIG. 9). A recess 214 is provided on the separating ring 213 in which a projection 223 of the second web 222 engages. An extension 224 is provided on the second web 222 on which a projection 225 is also formed. The projection 225 engages in a recess 215 on the base ring 212. As can be seen from the illustration according to FIG. 3, the extension 224 overlaps the guarantee seal 24 in the direction of the base ring 212. The extension 224 has a plurality of interruptions not designated in detail here along its circumference, which allow a better raising from the base ring 212 during the opening process of the infusion container 20.

A second end 231 of the wall part 23 is clamped between the separating ring 213 and the webs 221 and 222. As a result of this clamping, the wall part 23 is connected to the lid part 22 in a fluid-tight manner even after separation of the separating ring 213, which is explained with reference to the following FIGS. 10 and 11.

FIG. 4 shows a perspective view of the infusion container 20 from FIG. 1 during manufacture. In a first step a base part 21 is provided which has a hollow-cylindrical wall 211 as presently described. The wall 211 is arranged on the periphery of the base part 221 and extends contrary to the flow direction. A wall part 23 is arranged inside this wall 221. In the present case, the wall part 23 is configured in the form of a bellows. The wall part 23 is fabricated from a flexible plastic, in particular from a biologically degradable plastic, preferably from a biobased plastic. The wall part 23 comprises a first end 232 and a second end 231. The first end 232 is connected to the base part 21, in the present case by an adhesive bonding. Alternatively a welding can be provided.

The second end 231 has an outwardly directed bend (see on this matter FIG. 5) which rests on an upper end of the hollow-cylindrical wall 211. This bend is not shown in the present case. The hollow-cylindrical wall 211 is divided into a base ring 212 and a separating ring 213 (see on this matter FIG. 3).

FIG. 5 shows a detailed view from FIG. 4. The configuration of the second end 231 of the wall part 23 can be clearly seen. The second end 231 spans the guarantee seal 24 from the base ring 212 to the separating ring and extends radially beyond the separating ring 213.

FIG. 6 shows a perspective view of the infusion container 20 from FIG. 1 during manufacture, namely the step of combining the lid part 22 with the base part 21. It is understood that the dried infusion substance has been brought into the infusion container 20 or into the semifinished infusion container 20 shown in FIG. 4.

According to FIG. 6 a lid part 22 is provided. The lid part 22 comprises a first web 221 and a radially inwardly offset second web 222. These two webs 221 and 222 are formed substantially complementarily to the separating ring 213 to receive this. A support 41 is additionally formed on the base part 21 which has a filter sieve 40 as an integral part. The support 41 is formed substantially complementarily to a counter-piece of the inlet valve 10.

As can be seen from FIG. 6, the inlet valve 10 can thus be supported on the support 41.

FIG. 7 shows a detailed view of another manufacturing step. The lid part 22 is now in abutment with the second end 231 of the wall part 23. The extension 224 of the web 222 already extends into the interior of the hollow-cylindrical wall 211.

Subsequently the lid part is moved further in the direction of the hollow-cylindrical wall 211 so that the webs 221 and 222 are pushed over the separating ring 213. Accordingly, the projections 223 and 225 engage in corresponding recess 214 and 215 as shown in FIG. 3.

FIG. 8 shows a perspective view of the assembled infusion container 20. FIG. 8 allows a view of the guarantee seal 24 which is arranged between the base ring 212 and the separating ring 213. The guarantee seal 24 comprises in the present case a plurality of tear-off webs which are spaced apart from one another with corresponding openings (see on this matter also FIG. 9). As a result of the guarantee seal 24 on the one hand overlapping through the web 222 and the extension 224 (see FIG. 3) and as a result of the overlapping of a corresponding section of the second end 231 of the wall part 23, however, these openings are closed. In addition, the first web 221 is also configured in such a manner that it also overlaps the guarantee seal 24 or the openings between the tear-off webs.

FIG. 9 shows a detailed view of the guarantee seal 24. The guarantee seal 24 comprises a plurality of tear-off webs which are spaced apart from one another with an opening. The tear-off webs connect the base ring 212 to the separating ring 213. A recess 214 for receiving a corresponding counter-piece is arranged in the separating ring 213. A recess 215 is also arranged in the base ring 212 for receiving a counter-piece corresponding to this recess 215.

FIG. 10 shows the view according to FIG. 3 after breaking the guarantee seal 24. As a result of an infusion liquid pouring through the inlet valve 10 (see on this matter FIG. 1), an excess pressure forms inside the infusion container 20. The separating ring 213 is held firmly between the webs 221 and 222 so that the tear-off webs of the guarantee seal are accordingly exposed to a force until they tear. The projection 225 of the extension 224 is released from the recess 215. A displacement of the lid part or a removal of the lid part 22 from the base part 21 is made possible so that the folded wall part 23 can unfold.

FIG. 11 shows the view according to FIG. 10 after complete removal of the lid part 22 from the base part 21. The lid part 22 is merely connected by the wall part 23 to the base part 21. After further filling of the infusion container 20, this then adopts the form shown in FIG. 2B. The infusion beverage can be dispensed after a predetermined dwell time as described for FIG. 2B.

1-14. (canceled)

15. An expandable infusion container (20) for receiving a dried infusion substance for preparation of an infusion beverage, comprising a base part (21), a lid part (22) and a wall part (23) connecting the base part (21) and the lid part (22), wherein the wall part (23) has a variable length and is fastened with a first end (232) to the base part (21) and is connected with a second end (231) to the lid part (22), wherein the lid part (22) and the base part (21) are connected to one another via a destructible guarantee seal (24).

16. The infusion container (20) according to claim 15, wherein the guarantee seal (24) is configured as a tear-off film.

17. The infusion container (20) according to claim 15, wherein the guarantee seal (24) is configured as a plurality of tear-off webs.

18. The infusion container (20) according to claim 15, wherein the guarantee seal (24) is configured as an integral component of the base part (21).

19. The infusion container (20) according to claim 15, wherein the base part (21) comprises a hollow-cylindrical wall (211) that extends from the base part (21) in a direction of the lid part (22) and the wall (211) is divided by the guarantee seal (24) into a base ring (212) and a separating ring (213).

20. The infusion container (20) according to claim 19, wherein the second end (231) of the wall part (23) is clamped between the lid part (22) and the separating ring (213).

21. The infusion container (20) according to claim 20, wherein for clamping the wall part (23) the lid part (22) has two concentric webs (221, 222) which are or can be brought into operative connection with the separating ring (213).

22. The infusion container (20) according to claim 15, wherein a snap connection is provided for connection of the base part (21) to the lid part (22).

23. The infusion container (20) according to claim 21, wherein in order to provide the snap connection a projection (223) is provided on one of the two concentric webs (221, 222) for engagement in a corresponding recess (214) provided on the separating ring (213).

24. The infusion container (20) according to claim 23, wherein one or more axial extensions (224) which overlap the guarantee seal (24) are provided at least on one of the two concentric webs (221, 222).

25. The infusion container (20) according to claim 24, wherein a projection (225) for engaging in a corresponding recess (215) on the base ring (212) is provided on the axial extensions (224).

26. The infusion container (20) according to claim 15, wherein an inlet valve (10) is arranged on the lid part (22).

27. The infusion container (20) according to claim 15, wherein an outlet valve (11) is arranged on the base part (21).

28. The infusion container (20) according to claim 15, wherein a filter sieve (13) is arranged inside the infusion container (20), wherein the filter sieve is preferably arranged on the base part (21).
